(19) United States
(12) Patent Application Publication
(10) Pub. No.: US 2011/0205158 A1
(43) Pub. Date: Aug. 25, 2011

(54) Separable Mouse

(75) Inventor: Wei HSU, Taipei County (TW)

(73) Assignee: WEISTECH TECHNOLOGY CO., LTD., Chung Ho City (TW)

(21) Appl. No.: 12/712,177

(22) Filed: Feb. 24, 2010

(51) Int. Cl. G06F 3/033

(52) U.S. Cl. 345/164

(57) ABSTRACT

A separable mouse includes a top cover with an input device installed at the surface of the top cover. At least one first fastening element is set inside the top cover. A first circuit board set inside the top cover coupled to the input device for receiving the control signals transmitted from the input device. A bottom cover hosts a second circuit board which is set at the surface of the bottom cover, and a first connection element which is set on the first circuit board. A second connection element set on the second circuit board to connect the first connection element. Also, at least one second fastening element is set on the bottom cover to bind the first fastening element. Additionally, the separable mouse of the invention further comprises a separable-side-button module.

### FIELD OF THE INVENTION

The present invention in general is related to a pointing device in computer, and more specifically to a separable mouse which is used in computers and similar apparatuses.

### BACKGROUND OF THE INVENTION

Mouse is one of the pointing devices for controlling the movements of cursor on the monitor of the computer which is one of the most widely used pointing devices in computer and it can be classified into mechanical and optical mouse by its detection and decoding methods. The mechanical mouse is operated by the contact between bottom rolling wheel and table top, the rolling wheel is pushing the rolling bearings while moving the mouse, and the two rolling bearings arranged into two orthogonal axes, X- and Y-axis, respectively, further, each axis connects with disk shape encoder to generate signals, the generated signals can be converted into movements through the microprocessor, therefore the position of the cursor can be obtained. The way of operating the optical mouse is quite similar to operate the mechanical one, but with different encoder for detecting mouse's movement including a light source, which contains a sensor unit and a light emitting diode (LED), an optical mirror and a sensing IC, i.e., the optical mouse is utilizing the image movement detecting technology to determine the cursor's position. Nowadays, the optical mouse is the most common used mouse because they are more reliable than the mechanical one in terms of position sensing by replacing the rolling wheel position sensing mechanism into optical position sensing mechanism. Optical mouse includes cable and wireless communications. The operation principle for sensing position of the wireless optical mouse is very similar to the cable one, the main difference is that the cable optical mouse transmits signals through cable but the wireless optical mouse utilizes a wireless high frequency module instead. Most of the mentioned mice are not separable, exceptions are the mice with changeable cover mentioned in Taiwan patent M207935 and I267769. However, once the components controlling the movement, such as the button or rolling wheel, is damaged or failure then the whole mouse still need to be changed even its interior sensing components remain functional. Therefore, customers will suffer higher cost to get a new one and it also wastes much more resources.

### SUMMARY OF THE INVENTION

In accordance with a preferred embodiment of the present invention, there is provided a separable mouse. In general, at most of the time, the malfunctions in mouse are due to the failure of movement components, such as button or rolling wheel, but the internal sensing module and circuit board remain undamaged by the protection of cover. The cost of button or rolling wheel is relative cheap compared to the internal sensing module and circuit board. If customer has to replace a new mouse, because of the damage of those low cost components, which will waste money and the replaced mouse having plastic cover could also pollute the environment.

The present invention disclosed a separable mouse or position pointing device for computer to cope this issue. It includes a top cover with an input device installed at the surface of the top cover. At least one first fastening element is set inside the top cover. A first circuit board set inside the top cover coupled to the input device to receive the control signals transmitted from the input device. A bottom cover hosts a second circuit board which is set at the surface of the bottom cover, and a first connection element which is set on the first circuit board. A second connection element set on the second circuit board to connect the first connection element. Also, at least one second fastening element is set on the bottom cover to bind the first fastening element for engaging the top and bottom cover.

Additionally, the separable mouse of the invention further comprises a separable-side-button module which can be set in top cover. It includes a side plate, at least one side button, a side button circuit, and at least one second side button connecting element for jointing the second side button connecting element.

One of the advantages of the present invention is demonstrating a separable mouse which can allow users to change its top cover when its movement components, such as button or rolling wheel, are damaged. In an ordinary family there are parents with their children, their hands have different sizes and shapes, so it will be more convenient for them to buy different top covers for themselves depending their hand sizes and shapes without the needs for buying the whole mouse. If users would like to have both cable and wireless mouse and use one of them depending on the situation or their own choice from time to time, present invention can provide the same top cover in companying with a cable or wireless transmission function bottom cover. The users also can choose various separable-side-button modules, such as single-button, double-button, or multi-button modules; depend on their demands at different situation without the needs for purchasing a further whole new mouse.

### BRIEF DESCRIPTION OF THE DRAWINGS

FIG. 1 is the name view of the separable mouse;

FIG. 2 is the bottom view the separable mouse;

FIG. 3 is the exploded view of the separable mouse;

FIG. 4 is the top view of the top cover of the separable mouse;

FIG. 4A is the name view of the top cover of the separable mouse;

FIG. 5 is the top view of the bottom cover of the separable mouse;

FIG. 5A is the name view of the bottom cover of the separable mouse;

FIG. 6 is the exploded view of the separable mouse;

FIG. 7 is the bottom view of the top cover of the separable mouse;

FIG. 8 is the name view of the plug;

FIG. 8A is the name view of the plug;

FIG. 9 is the top view of the bottom cover with wireless module of the separable mouse;

FIG. 10 is the illustration of the partial top cover and side plate interior of the separable module; and

FIG. 11 is the name view of the side plate interior.

### DETAILED DESCRIPTION OF THE PREFERRED EMBODIMENT

Reference will now be made in detail to embodiments of the present invention, examples of which are illustrated in the accompanying drawings.

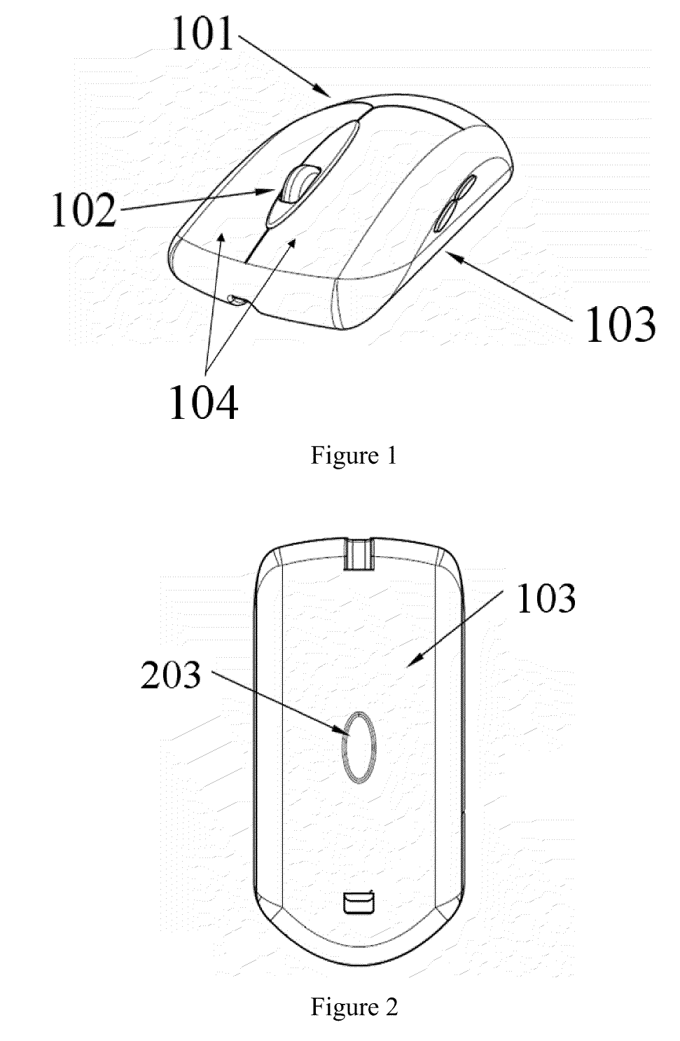

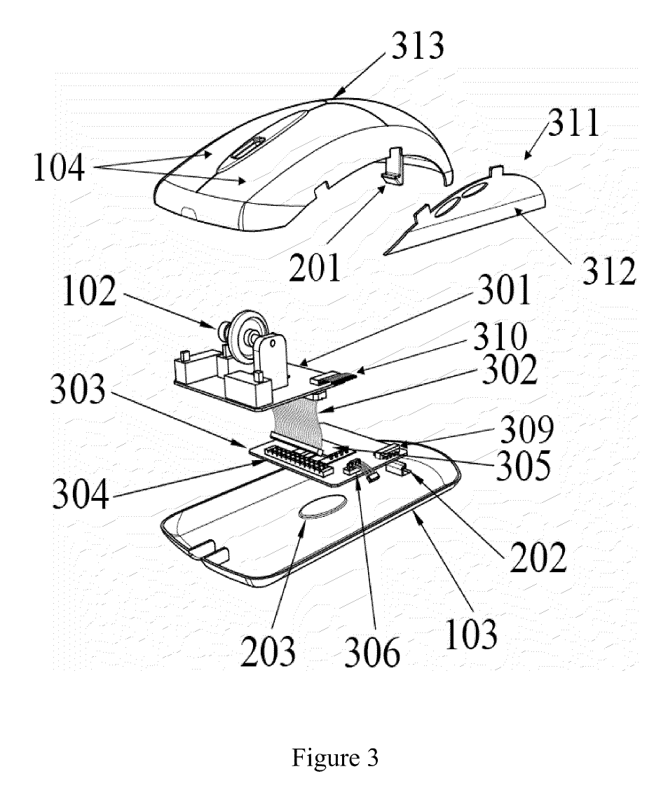

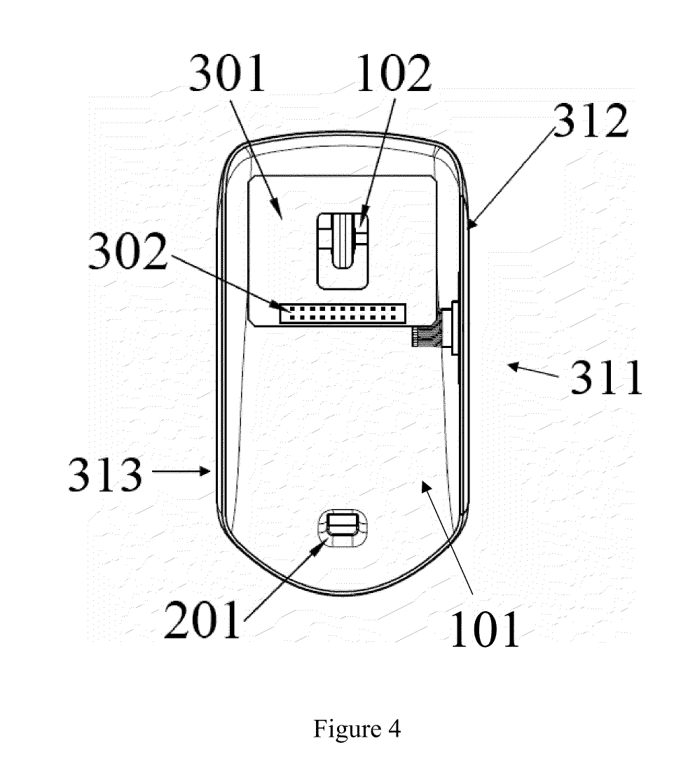

In the present invention, a separable mouse is disclosed which includes any cable and wireless mouse. For example, a mouse connected with a universal serial bus (USB) port or a wireless module. In FIGS. 1 and 2, the separable mouse includes a top cover 101, bottom cover 103, an opening 203, and at least one input device. The input device contains a rolling wheel 102 and an elastic press button apparatus 104. As illustrated in FIG. 3, the internal elements further comprise a first fastening element 201, a second fastening element 202, a first circuit board 301, a first connecting element 302, a second circuit board 303, a second connecting element 304, a sensing module 305, a transmission element 306, and a micro-controller 309. In addition, the separable mouse is further comprises a separable-side-button module 311, the separable-side-button module 311 is further including a side plate 312 and partial top cover 313. In the preferred embodiment, wherein the side plate 312 is separable from the top cover 313 and a first button connecting element 310 is set on the first circuit board 301 for connecting the corresponding side button module 311 and transmitting the signals from the separable-side-button module 311.

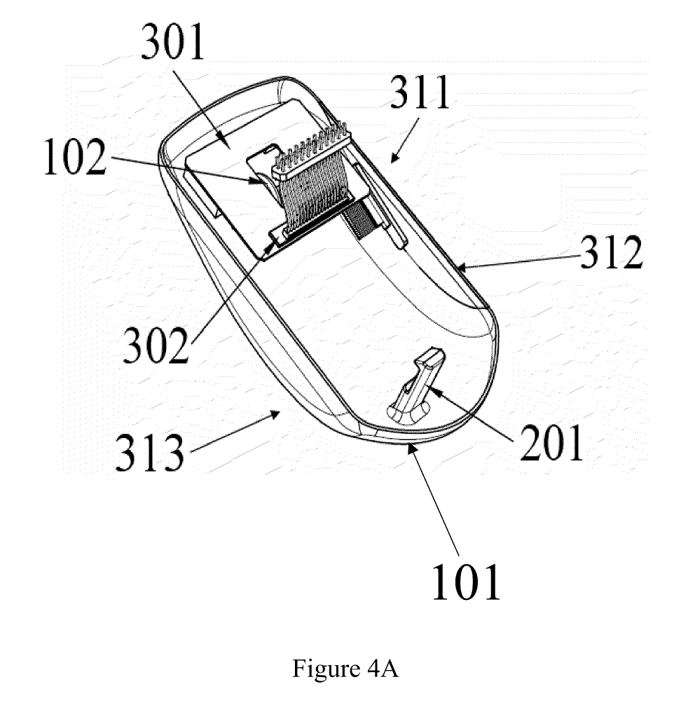

As shown in FIGS. 4 and 4A, the top cover and its interior elements are illustrated which includes a first fastening element 201, a first connecting element 302, at least one input device, a first circuit board 301, and a separable-side-button module 311. In one preferred embodiment, the separable-side-button module includes a side plate 312 and partial top cover 313, the side plate is separable from the partial top cover 313, and the at least one input device comprises a rolling wheel 102. To be more specific, the first circuit board can be fastened or fixed on the inner side of top cover 101 through any attachment such as glue in or embed in. Besides, referring to FIG. 3, the first connecting element 302 can be set on the corresponding surface between the first circuit board 301 and second circuit board 303 for connecting the second connecting element 304 and transmitting the controlled signal from the input device to the micro-controller 309.

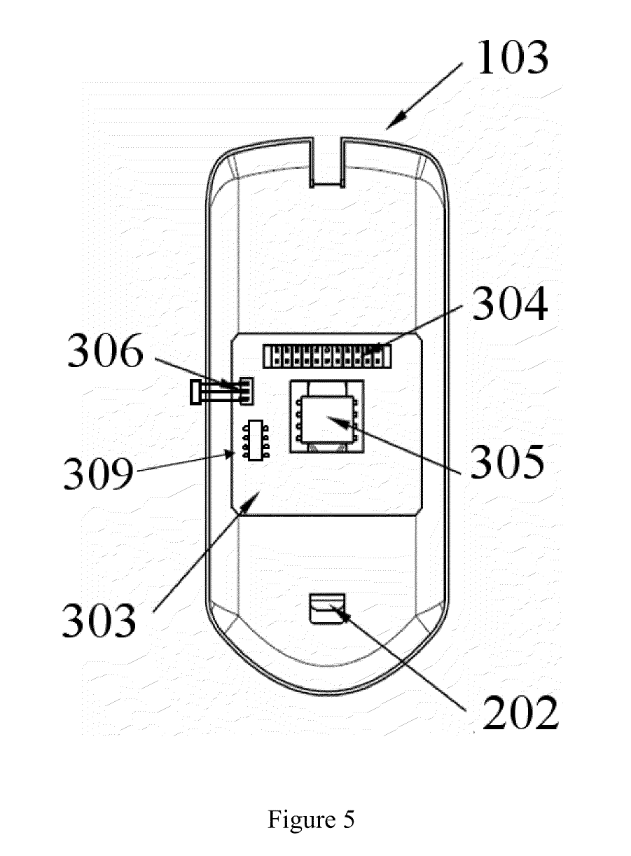

In one of the preferred embodiment of the present invention, as shown in FIGS. 5 and 5A, the bottom cover 103 of the separable mouse and its interior elements include at least one second fastening element 202, a second connecting element 304, a second circuit board 303, a sensing module 305, transmission element 306, a micro-controller 309, and an opening 203 set in the bottom cover 103. The second circuit board 303 can be fastened or fixed on the inner side of bottom cover 103 through glue in or embed in. The sensing module 305 can be set on the surface of the second circuit board 303 to detect the movement of bottom cover 103 and couple to micro-controller 309 for transmitting the detected movement signal. The micro-controller 309 can be set on the surface of the second circuit board 303 for integrating the signals from the at least one input device and the movement of the sensing module 305 and coupled to the transmission element 306. The transmission element 306 can be set on the surface of the second circuit board for transmitting the control and movement signals to a receiving device. Also referring to FIG. 3, a single or plurality of the second fastening elements 202 can be set on the inner surface of the bottom cover to joint the single or plurality of the first fastening elements 201. The second connecting element 304 can be set on the corresponding surface between the first circuit board 301 and second circuit board 303 for connecting the first connecting element 302.

One of the preferred embodiments in the present invention, the first connecting element 302 and the second connecting element 304 can be combined as a circuit board connector for connecting the first circuit board 301 and the second circuit board 303. As illustrated in FIG. 3, 4, or 5, the first connecting element 302 could be a flat cable with multiple flat pins (FIG. 4), the second connecting element 304 can be a flat socket or vice versa. The circuit connector can be a single-row flat pin connector, double-row flat pin connector, or multiple-row flat pin connector, etc.

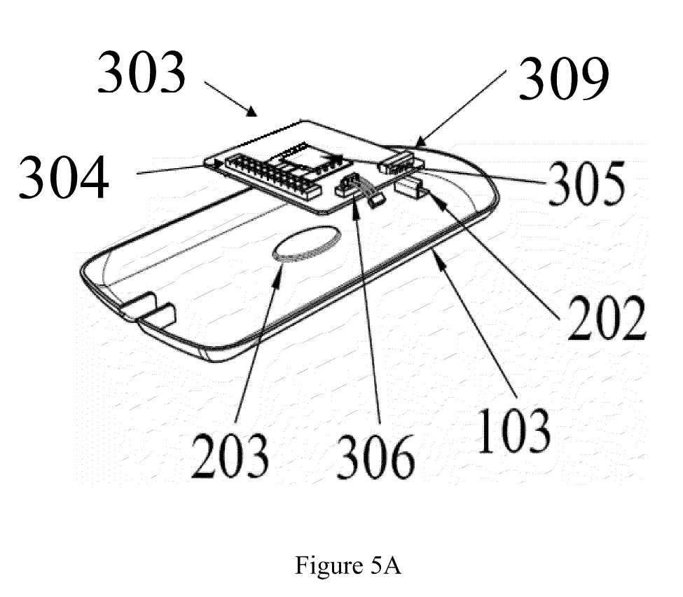

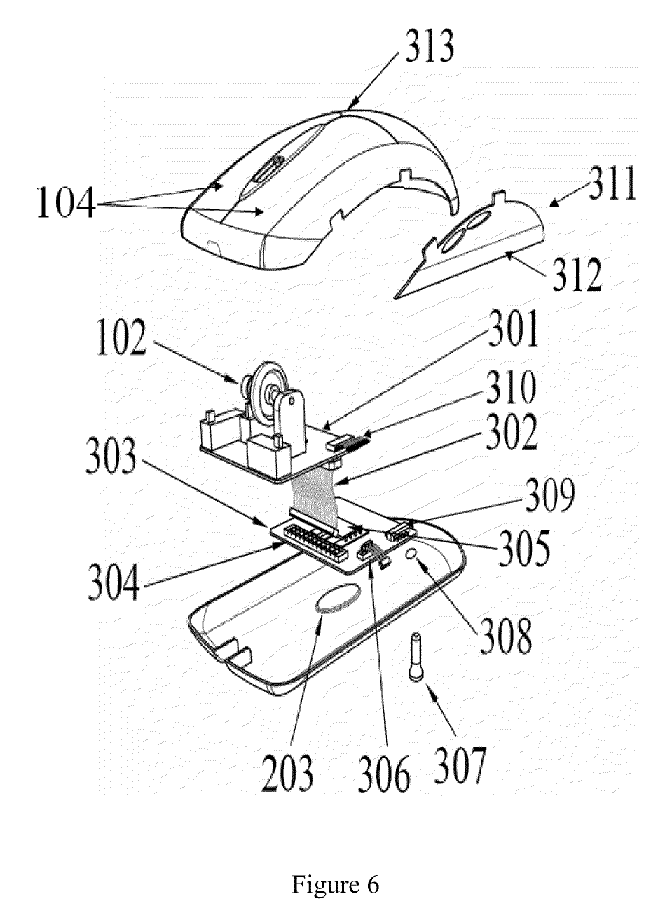

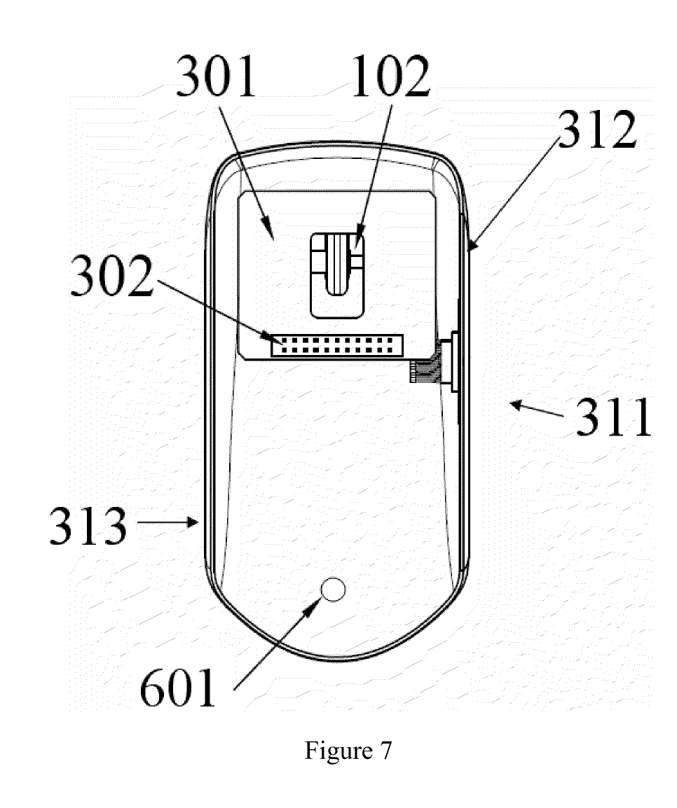

Other preferred embodiments of the present invention, as demonstrated in FIGS. 3, 4, and 4A, the first fastening element 201 can be an elastic tenon and according to FIGS. 5 and 5A, the second fastening element 202 can be a slot. The elastic tenon includes a main body and an elastic component where the shape of the main body and the slot are matched so that their will joint without gap, the elastic component can be fixed in the space between the slot and bottom cover 103 and be exposed to outside of the bottom cover 103. Based on the characteristic of the elastic component, it will be deformed while the pressure being applied and resulting the disconnection between the elastic tenon and the slot without causing any structure damage. In the present invention, as shown in FIGS. 6 and 7, the first fastening element 201 can be a first hole 601, the second fastening element 202 can be a second hole 308, and according to the disclosed separable mouse of the present invention, the fastening element can further comprise a plug 307 to joint the first 601 and second hole 308, wherein the first hole 601 and the second hole 308 have exact the same shape and their corresponding positions are overlap while the top and bottom cover jointing together so that the plug can pass through the first and second hole and be used to fasten the top 101 and bottom cover 103 firmly. In the present invention, as illustrated in FIGS. 8 and 8A, the plug 307 includes a cylinder body and a foldable ring, while the mouse is in use, i.e., the top and bottom cover should be fastened together firmly, the foldable ring can be folded into the position that perpendicular to the cylinder body and attached closely onto the outside surface of the bottom cover. If the components of the mouse need to be separated, the foldable ring can be folded into a position that is parallel to the cylinder body and users can put their finger into it to pull the plug 307 out, therefore the plug 307 and the first hole and the second hole can be separated without damage the structure of them. Other than the above fastening method, a hidden fastening (Taiwan patent I292521) or magnetic fastening method (Taiwan patent I292299) can be incorporated into the present invention.

In other preferred embodiments of the present invention, as shown in FIG. 1, the input device of the separable mouse includes rolling wheel 102 and a plurality of elastic press apparatus 104 with either the same or different sizes. The elastic press apparatuses 104 and rolling wheel 102 for delivering the control signal to the first circuit board 301 can be located on the top surface of the top cover 101, the elastic press apparatuses can be located on two sides of the rolling wheel 102, wherein the first circuit board 301 has at least one rotation contact and/or at least one button electronic switch for receiving the delivered control signal from the elastic press apparatuses 104 and rolling wheel 102. In addition, the shaft of the rolling wheel 102 contacts with the rotation contact for detecting the rotation angle of the rolling wheel and the press electronic switches can be located below the press elastic apparatuses 104 and match their positions for detecting the movements of the press elastic apparatuses 104. For people having ordinary skill in the art that various modifications and variation can be made in the present invention, the rolling wheel mentioned above is not limited to a vertical rotating rolling wheel and the input devices are also not limited to the mentioned example, which can comprise but not be limited to single rolling wheel or a plurality of rolling wheels that can rotate around its shaft, single track ball or a plurality of track balls that can rotate freely, or their combinations.

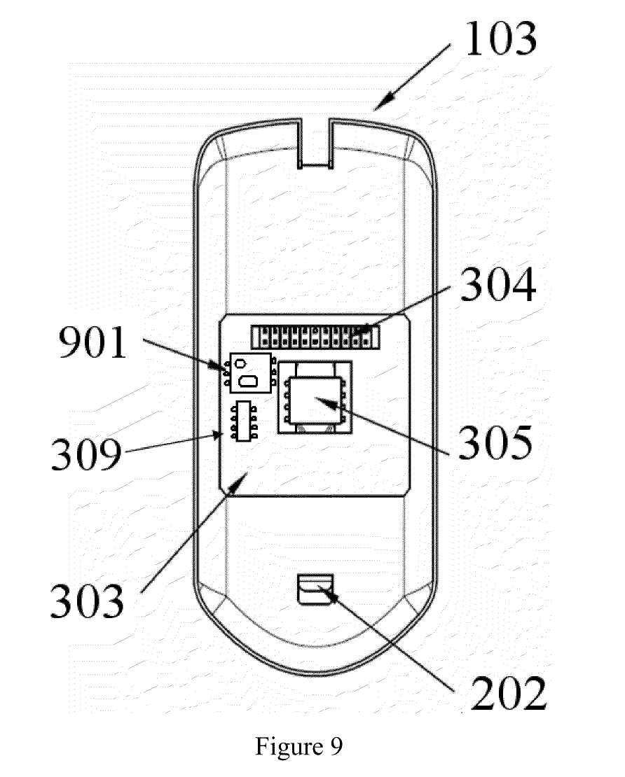

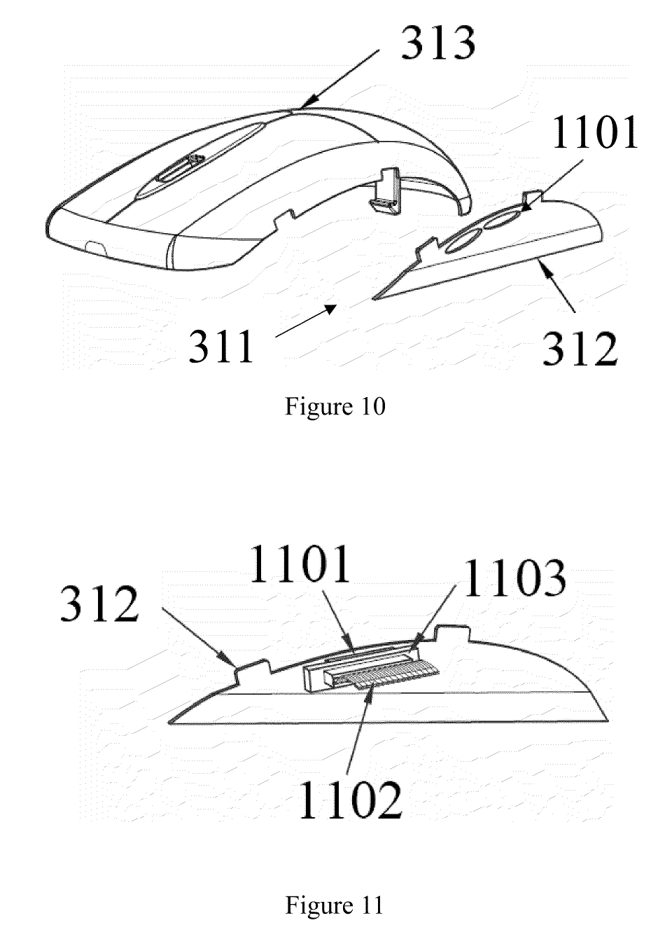

Referring to FIG. 10, which is the illustration of the side button module 311, wherein the separable module 311 is located on the top cover 101 containing a side plate and partial top cover 313, the side plate 312 is separable from the partial top cover 313, the side plate 312 has side button 1101 with at least one convex portion, and the partial top cover 313 has at least one notch or groove for matching the corresponding convex portion. The convex portion of the side plate 312 matches the notch and joints the side plate 312 and the partial top plate 313 together firmly. As seen in FIG. 11, it shows another illustration of the side button module 311. The side button module 311 is set on the top cover 101 comprising a side plate 312, at least one side button 1101, at least one second side button connecting element 1102, and at least one side button circuit board 1103. The side button circuit board 1103 is coupled to the side button 1101 for receiving control signal from it; the second side button connecting element 1102 is coupled to the side button circuit board 1103 for transmitting the control signal. Further more, referring to FIG. 3, at least one first side button connecting element 310 is set on the first circuit board 301 for connecting the corresponding second side button connecting element of the separable-side-button module 311. As illustrated in FIGS. 3 and 11, the first side button connecting element 310 can be a flat cable with a plurality of flat pins and the second side button connecting element 1102 can be a flat cable with a plurality of corresponding flat sockets, or the vice visa.

Referring to FIGS. 2 and 3, the opening 203 is set on the bottom cover 103 for providing the sensing module 305 to detect the movements of the mouse. The sensing module 304 includes but is not limit to a track ball module, an optical module or laser optical module, wherein the track ball module comprises a track ball, at least two pressure rolling bearings, and a decoders connected to the pressure rolling bearings. The optical or laser optical module includes a sensor unit, a light emitting diode (LED) light source, optical mirror, and a sensing IC.

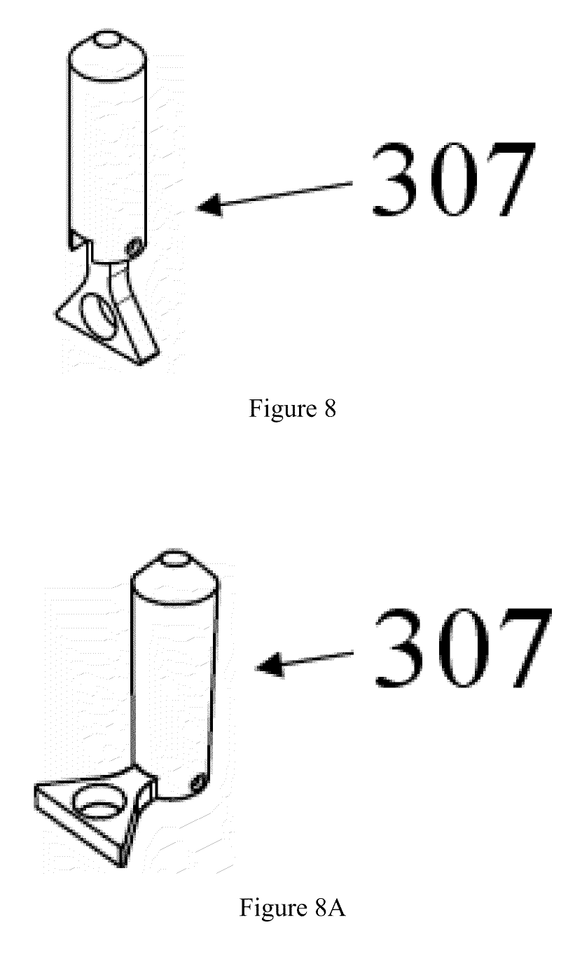

The transmission element 306, as shown in FIGS. 3 and 6, can be a communication port (COM port) cable, a personal system/2 (PS/2) cable, or a universal serial bus (USB) cable. As seen in FIG. 9, the transmission element 306 can be replaced by a wireless module 901 including a wireless high frequency module or a sensor light module. The mouse with wireless module 901 further includes a power supply and a switch; the power supply has one or a plurality of batteries, rechargeable or regular one, for providing the electric power. The switch can be set on the bottom of the bottom cover and link to the power supply for turning on or off the electric power. The receiving device can be a personal computer (PC), a notebook, or a netbook.

It will be apparent to those skilled in the art that various modifications and variation can be made in the present invention without departing from the spirit or scope of the invention. Thus, it is intended that the present invention provided they come within the scope of the appended claims and their equivalents.

What is claimed is:

1. A separable mouse includes:
a top cover with at least one first fastening element and at least one input device installed at the surface of the top cover;
a first circuit board set inside the top cover coupled to the input device for receiving the control signals transmitted from the input device, at least one first connecting element set in the first circuit board;
a bottom cover with at least one second fastening element for connecting the at least the first fastening element to engage the top and the bottom cover;
a second circuit board set at the surface of the bottom cover including at least one second connecting element for connecting the at least one first connecting element and receiving the control signal from the at least one first connecting element;
a sensing module coupled to the second circuit board for detecting the movements of the bottom cover; and
a transmission element coupled to the second circuit board for transmitting the control signal and the movement signal to a receiving device.

2. The separable mouse of claim 1, wherein the at least one first fastening element further comprises an elastic tenon.

3. The separable mouse of claim 2, wherein the at least one first fastening element further comprises a slot for joint the elastic tenon.

4. The separable mouse of claim 1, wherein the at least one first fastening element further comprises a first hole, the at least one second fastening element further comprises a second hole.

5. The separable mouse of claim 4 further comprises a plug for passing through and connecting the first hole and the second hole to joint the top cover and bottom cover.

6. The separable mouse of claim 1, wherein the at least one first connecting elements includes a flat cable with one free end, the free end has a plurality of flat pins, and the at least one second connecting element is composed of a plurality of flat sockets for connecting a plurality of the flat pins.

7. The separable mouse of claim 1, wherein the at least one first connecting element further comprises a first flat cable with a free end, the free end has a plurality of flat sockets, and the at least second connecting element is composed of a plurality flat pins for connecting a plurality of the flat sockets.

8. The separable mouse of claim 1, wherein the at least one input device further comprises at least one rolling wheel and the first circuit board has at least one rotation contact for sensing the rotation of the rolling wheel.

9. The separable mouse of claim 1, wherein the at least one input device further comprises at least one elastic press apparatus and the first circuit board includes at least one press electronic switch, the elastic press apparatus is used for pressing the press electronic switch.

10. The separable mouse of claim 1 further comprises a microcontroller set on the second electric board and coupled to the transmission device for integrating the control signal and the movement signal.

11. The separable mouse of claim 1 further comprises a separable-side-button module which includes:
at least one side button;
at least one second side button connecting device; and
at least one side button circuit board, wherein the at least one side button is coupled to the at least one side circuit board and the at least second side button coupled to the at least one side button circuit board having at least one side button connecting element for connecting the corresponding second side button element.

12. The separable mouse of claim 1, wherein the separable-side-button module is set on a side plate, the side plate can be separable from the top cover, the top cover has at least one convex portion, and the top cover has at least one slot for jointing said convex portion.

13. The separable mouse of claim 1, wherein the first side button connecting element comprises a second flat cable, the second flat cable has a free end with a plurality of flat pins, and the second side button connecting element including a plurality of flat sockets for connecting a plurality of the flat pins.

14. The separable mouse of claim 1, wherein the first side button connecting element comprises a second flat cable with a free end, the free end has a plurality of flat sockets including a plurality of flat pins for connecting a plurality of the flat sockets.

15. The separable mouse of claim 1, wherein the transmission element comprises a communication port (COM port) cable, a personal system/2 (PS/2) cable or a universal serial bus (USB) cable.

16. The separable mouse of claim 1, wherein the transmission element comprises a wireless module and a power supply coupled to the second circuit board.

17. The separable mouse of claim 15, wherein the wireless module comprises a wireless high frequency module or a sensor light module.

18. The separable mouse of claim 1, wherein the sensing module comprises an optical module, a laser optical module, or a track ball module.

19. The separable mouse of claim 1, wherein the receiving module comprises a personal computer (PC), a notebook, or a netbook.
